(19) United States
(12) Patent Application Publication
(10) Pub. No.: US 2005/0226977 A1
(43) Pub. Date: Oct. 13, 2005

(54) Liquified Saffron

(76) Inventor: Reza Bozorgmehr, Palm Desert, CA (US)

Correspondence Address: REZA - BOZORGMEHR, 74791 SHERYL AVE, PALM DESERT, CA, 92260, US

(21) Appl. No.: 11/102,608

(22) Filed: Apr. 8, 2005

Related U.S. Application Data
(60) Provisional application No. 60/560,688, filed on Apr. 8, 2004.

(51) Int. Cl. A23P 1/00

(52) U.S. Cl. 426/481; 426/518

(57) ABSTRACT

The present invention relates to, a method, in which, Saffron, a natural spice is grounded, and mixed with food-grade solvent such as water, in a container for a period of one to eight hours. In this period of maceration an agitator is utilized to both agitate and stir the solution in a low light environment, so that maximum amount of pigments, flavor and aroma is extracted from the solution. The final product from this process, then will be passed through a filtration system, so that debris and grounded particles can be removed as a result an amber color solution with intense aroma, flavor and color is achieved, which is referred to as Saffron solution here fort.

### FILED OF THE INVENTION

The present invention is a method in which Saffron can be prepared in an easy manor, while minimizing the lost.

A solution of Saffron, water or other food-grade solvent both water and oil base, food-grade preservative and food-grade propellant can be placed in a spray can and or spray bottle, to Spence Saffron in a spray form to any food, beverage and frozen food product.

### OBJECT OF THIS INVENTION

The object of this invention is to, use Saffron a natural spice in a spray can, or bottle for ease of use on food( cold and hot), Baked goods, drinks and Frozen food including ice cream and frozen yogurt.

### DETAILED DESCRIPTION OF THIS INVENTION

Saffron a natural spice will be prepared with the new method for ease of use according to the following:
1. Saffron will be mixed with a food-grade solvent such as water in a container.
2. An agitator will then be placed on or in the mixture's container, to both stir and agitate the mixture, while the Saffron in the mixture is being macerated for a period of 1 to 8 hours.
3. Prepared solution will then be passed through a filtering system to remove debris and particles.
4. Filtered solution will then be placed in a spray can and food-grade propellant will be added, or in a spray bottle without use of any propellant.
5. Prepared spray can or bottle can now be used to Spence Saffron solution on or into any food for great flavor, aroma and color.

### EXAMPLES

### Example 1

Saffron 0.5-5%

Water 75-80%

Propellant 18-20%

Sorbic Acid Less than 1%

### Example 2

Food-grade oil base solvent 75-80%

Saffron 0.5-5%

Propellant 18-20%

Preservative Less than 1%

### DETAILED DESCRIPTION OF THIS INVENTION

Saffron a natural spice will be prepared with the new method for ease of use according to the following:
1. Saffron will be mixed with a food-grade solvent such as water in a container.
2. An agitator will then be placed on or in the mixture's container, to both stir and agitate the mixture while the Saffron in the mixture is being macerated for a period of 1 to 8 hours.
3. Prepared solution will then be passed through a filtering system to remove debris and particles.
4. Filtered solution will then be placed in a spray can and food-grade propellant will be added, or in a spray bottle without use of any propellant.
5. Prepared spray can or bottle can now be used to Spence Saffron solution on or into any food for great flavor, aroma and color.

1. A method, in which Saffron a natural spice is grounded, and mixed with a food-grade solvent such as water.
The above mixture is then placed in an agitator for a macturation period of one to eight hours in which time during this period, saffron will be macerated, agitated, and steer to achieve maximum amount of saffron's pigments, flavor, color and aroma in the solution.
The final product of this process will then be filtered, and placed in a spray can, utilizing food-grade propellant, and without propellant for use in a spray bottle.

2. A method as claimed in claimed 1, wherein the Saffron solution is free of debris and particles.

3. A method as claimed in claimed 1, wherein solution is placed in a spray canister.

4. A method as claimed in claimed 1, wherein solution is placed in a spray bottle.

5. A method as claimed in claimed 1, wherein food-grade solvent is at about 75% to 80% of the total weight.

6. A method as claimed in claimed 1, wherein the food-grade propellant is at about 20% of total weight.

7. A method as claimed in claimed 1, wherein Saffron is at about 0.5% to 5% of the total weight.

8. A method as claimed in claimed 1, wherein the Saffron solution is filtered.

9. A method as claimed in claimed 1, wherein the Saffron solution is placed in different size spray canister.

10. A method as claimed in claimed 1, wherein the Saffron solution is placed in different size spray bottle.

11. A method as claimed in claimed 1, wherein no food-grade propellants are needed when spray bottle is used.

12. A method as claimed in claimed 1, wherein solvents are of a food-grade solvents.

13. A method as claimed in claimed 1, wherein propellants are of food-grade propellants.

14. A method as claimed in claimed 1, wherein food-grade preservatives are used.

15. A method as claimed in claimed 1, wherein the Saffron solution's PH is between 6 and 8.
